(19) United States
(12) Patent Application Publication
(10) Pub. No.: US 2021/0031312 A1
(43) Pub. Date: Feb. 4, 2021

(54) AUTOMATED RIDE-ON STUD WELDER

(71) Applicant: William L. Holm, St. George, UT (US)

(72) Inventor: William L. Holm, St. George, UT (US)

(21) Appl. No.: 16/945,280

(22) Filed: Jul. 31, 2020

Related U.S. Application Data
(60) Provisional application No. 62/880,775, filed on Jul. 31, 2019.

(51) Int. Cl. B23K 37/02; B23K 9/20; B62D 55/18; B60K 5/00; B60N 2/015

(52) U.S. Cl. CPC B23K 37/0294; B23K 9/206; B23K 9/20; B23K 37/0247; B60N 2/015; B23K 37/0229; B62D 55/18; B60K 5/00; B23K 37/0252

(57) ABSTRACT

The automated ride-on stud welder eliminates the fatigue and hazards associated with stud welding by having a motor which powers a hydraulic system and a set of tracks. A seat is coupled to the automated ride-on stud welder and controls are used to direct its movement. A bulk stud storage bin stores various types of studs. These studs are moved into position via a stud track that loads studs into the stud welding system that is attached to the gantry. In addition, there is a stud attachment mechanism for ease of attaching studs to a welding surface.

### CROSS-REFERENCE TO RELATED APPLICATIONS

This application claims the benefit of U.S. Provisional Application Ser. No. 62/880,775, filed on Jul. 31, 2019, which is incorporated herein by reference.

### TECHNICAL FIELD

The present disclosure relates to stud welding. More specifically, the present disclosure relates to a machine to assist a welder while welding studs.

### BACKGROUND

For years, welders have been plagued with fatigue and hazardous conditions while on the job, which slows the welder's production. For example, the stud welding industry involves dragging a heavy copper electrical cord with lengths up to 300 ft. Often, this heavy cord will snag on the previously welded studs. It is also very fatiguing on the laborer to retrieve and carry studs throughout a day's labor. In addition, the laborer is also in a bent over position for the duration of the welding process, which is very straining on the welder. Being bent over also exposes the laborer to sudden bursts of sparks that can put the laborer in hazard of being burned.

The laborer may also be subjected to a puff of hazardous fumes during the welding process. These fumes are in the laborer's face as a result of the bent over position. Due to the fatigue and hazard that a stud laborer will be subjected to, their production diminishes immensely. When laborers become fatigued, their production not only diminishes, but they may also be more susceptible to making mistakes. Often, these mistakes may be dangerous to the laborer, as well as the individuals who may be working nearby.

Accordingly, there is a need to overcome the fatigue, frustration, and hazardous conditions associated with stud welding in general, and there is a need to increase a welder's production capacity. The present invention solves these issues and other issues.

### SUMMARY OF EXAMPLE EMBODIMENTS

In one embodiment, the automated ride-on stud welder comprises a gas-powered motor, an electrical system powered by the gas-powered motor, a set of tracks to convey the automated ride-on stud welder, a seat coupled to the automated ride-on stud welder, hand operated controls, and a storage bin that stores and carries various types of studs. The automated ride-on stud welder further comprises a collator mechanism and an orientation chute coupled to the storage bin for automatically orienting the studs and collating them, a stud track coupled to the bulk stud storage bin which allows the studs to slide to the stud loading mechanism, roller chain flights to collate and project studs into the stud track, and a stud indexing mechanism.

The automated ride-on stud welder also includes two handles, a gantry securing the welding system (e.g., stud welding gun), and a laser pointer coupled to the gantry that allows the laser pointer to be centered in a ring of a pre-spread ferrule. The two handles may assist the welder to precisely move the stud welding system to the correct position. The automated ride-on stud welder may also include stud attachment components, a push button located on the handle to activate the stud attachment cycle, and an electric actuator to raise and lower the welding system when the push button has been actuated. To weld a stud to a desired location, after the push button is actuated, a stud holder positions the stud until the stud is seated in the stud collet. Two mechanical arms resting together with a spring with a conical shaped guide for the stud and ferrule ensure proper positioning of the stud. With sufficient downward force, a deck pressure spring is overcome allowing the stud to protrude and be welded to the desired surface.

In one embodiment, the automated ride-on stud welder comprises a support arm coupled to the back side of the automated ride-on stud welder capable of swinging from the rear right to the rear left, allowing the stud welder system cord to be moved away from previously welded studs.

In one embodiment, the automated ride-on stud welder comprises a fan for the operators benefit (e.g., blowing hazardous fumes away from the welder), a plurality of guards attached to the machine, and quick-attach pulleys that are connected horizontally on the welding surface to a row of studs to assist in moving the stud welding system electrical cord.

### BRIEF DESCRIPTION OF THE DRAWINGS

FIG. 1 is a front, left side perspective view of an automated ride-on stud welder;

FIG. 2 is a front, right side perspective view of an automated ride-on stud welder;

FIG. 3 is a front elevation view of an automated ride-on stud welder;

FIG. 4 is a top plan view of an automated ride-on stud welder;

FIG. 5 is a rear elevation view of an automated ride-on stud welder;

FIG. 6 is a left side elevation view of an automated ride-on stud welder;

FIG. 7 is a right side elevation view of an automated ride-on stud welder;

FIG. 8 is a rear elevation view of a stud holding mechanism, a stud welding system, and a gantry of an automated ride-on stud welder in a first position;

FIG. 9 is a right side elevation view of a stud holding mechanism, a stud welding system, and a gantry of an automated ride-on stud welder in a first position;

FIG. 10 is a rear elevation view of a stud holding mechanism, a stud welding system, and a gantry of an automated ride-on stud welder in a second position;

FIG. 11 is a right side elevation view of a stud holding mechanism, a stud welding system, and a gantry of an automated ride-on stud welder in a second position;

FIG. 12 is a rear elevation view of a stud holding mechanism, a stud welding system, and a gantry of an automated ride-on stud welder in a third position;

FIG. 13 is a detailed view of the circle D of FIG. 12 of a conical guide and a stud collet of an automated ride-on stud welder;

FIG. 14 is a right side elevation view of a stud holding mechanism, a stud welding system, and a gantry of an automated ride-on stud welder in a third position;

FIG. 15 is a rear elevation view of a stud holding mechanism, a stud welding system, and a gantry of an automated ride-on stud welder in a fourth position;

FIG. 16 is a detailed, cross-sectional view of circle D of FIG. 17 of a stud holder mechanism of an automated ride-on stud welder in a fourth position;

FIG. 17 is a right side elevation view of a stud holding mechanism, a stud welding system, and a gantry of an automated ride-on stud welder in a fourth position; and

FIG. 18 is a front elevation view of an electrical system with a housing and a plurality of switches of an automated ride-on stud welder.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

While the forgoing examples are illustrative of the principles of the present invention in one or more particular applications, it will be apparent to those of ordinary skill in the art that numerous modifications in form, usage, and details of implementation can be made without the exercise of inventive faculty, and without departing from the principles and concepts of the invention.

As previously discussed, there is a need to overcome the fatigue, frustration, and hazardous conditions associated with stud welding in general and there is a need to increase a welder's production capacity. The present invention solves these issues and other issues.

Using a stud welder is a demanding job that brings with it many hazardous conditions. These hazardous conditions typically arise from the welder becoming fatigued rather quickly due to the bodily positions that the welder must be in to perform their job. Additionally, the welder uses equipment that is heavy and cumbersome, such as the stud welder with its long cord. The automated ride-on stud welder solves these issues, and other issues, by putting the burden on the automated ride-on stud welder instead of the welder. The automated ride-on stud welder allows the operator to be in a seated position, move the electrical cord so that it will not be snagged on previously placed studs or other equipment, and carry numerous studs without becoming fatigued.

The automated ride-on stud welder described herein generally comprises a motor that operates a set of tracks so as to move the automated ride-on welder to a desired position. Once the automated ride-on stud welder is in the desired position, an electrical system raises and lowers a stud gun. To weld the studs, the automated ride-on stud welder automatically places a stud into the stud welding system (e.g., a welding gun). It will be appreciated that the automated ride-on stud welder diminishes welder fatigue and increases productivity. Accordingly, all of this will lead to more efficient workers, precise welds, and a competitive advantage.

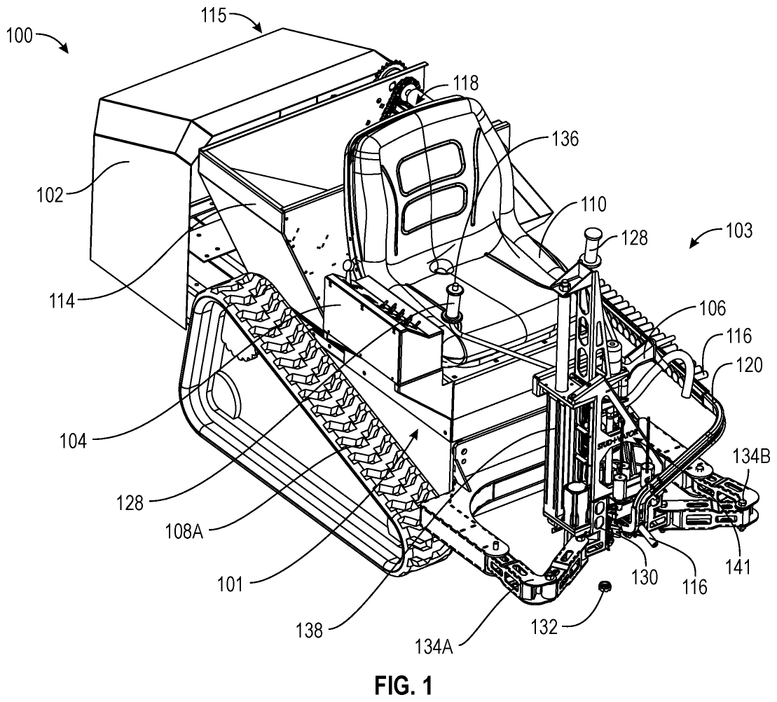

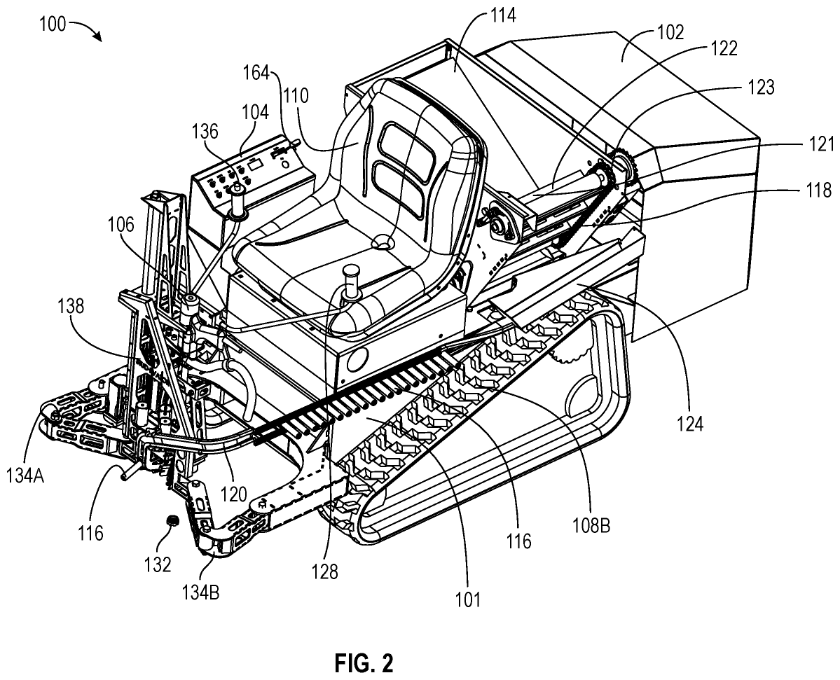

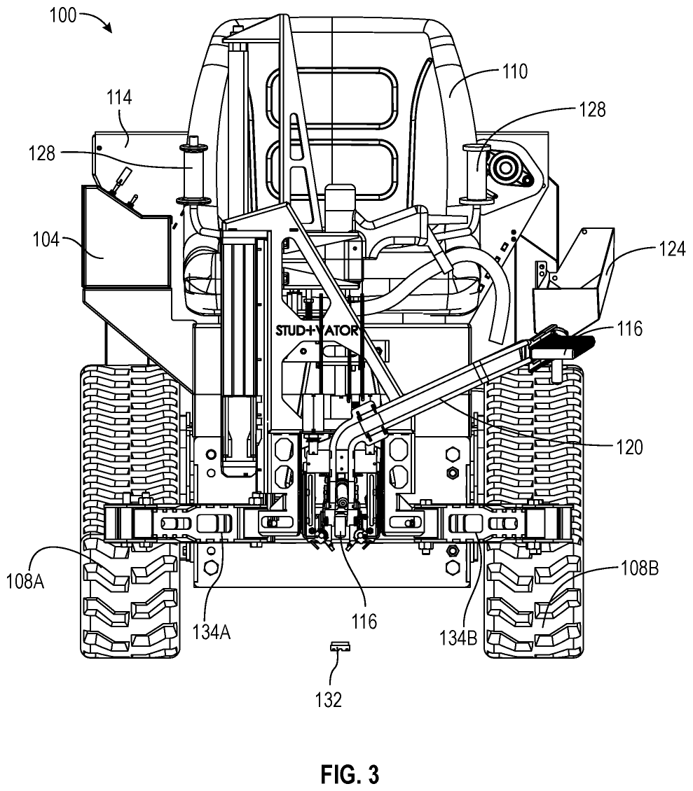

In one embodiment, as shown in FIGS. 1-3, the automated ride-on stud welder 100 comprises a chassis 101 with a motor 102, which may be powered by gas, diesel, electricity, etc., an electrical system 104 that raises and lowers a stud welding system 106, which may be a welding gun or any other type of welding device, on a front portion 103 of the automated ride-on stud welder. In some embodiments, the motor 102 also powers a hydraulic system to operate the stud welding system 106. The automated ride-on stud welder 100 is conveyed by a set of tracks 108A, 108B; however, other types of conveyance means may be used, such as wheels. A seat 110 may be coupled to the automated ride-on stud welder 100, which allows for comfortable operation of the automated ride-on stud welder 100 and prevents exhaustion for the welder. In one embodiment, the seat 110 may be adjustable up and down as well as forward and backward so as to accommodate the stature of any welder.

The automated ride-on stud welder 100 may be equipped with standard driving joysticks, foot pedals, or other steering mechanisms to allow a user to easily maneuver the automated ride-on stud welder 100. For example, one or more joysticks may be used to control each track 108A, 108B, or foot pedals may be positioned on the front of the automated ride-on stud welder 100 with the right pedal controlling the right track 108B and the left pedal the left track 108A.

Further, the automated ride-on stud welder 100 comprises a storage bin 114, located at a rear portion 115, to transport studs 116. With the automated ride-on stud welder 100 having the storage bin 114, the welder will not have to hand carry studs from welding site to welding site. As can be appreciated, a major advantage of the automated ride-on stud welder 100 over the prior art is that the automated ride-on stud welder 100 frees previous welders from many issues associated with stud welding and provides many benefits, such as being in a seated position while operating the automated ride-on stud welder 100 and not having to carry heavy stud loads.

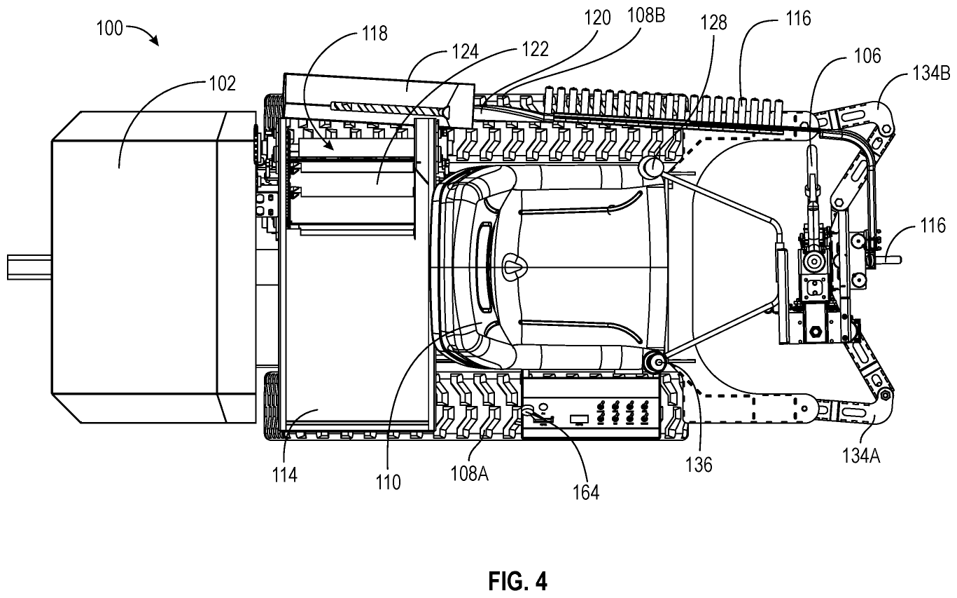

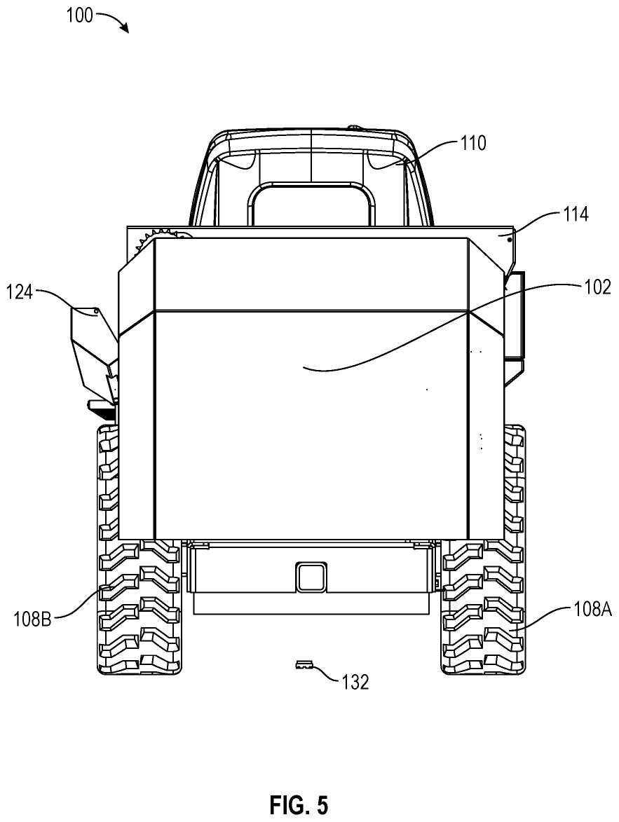

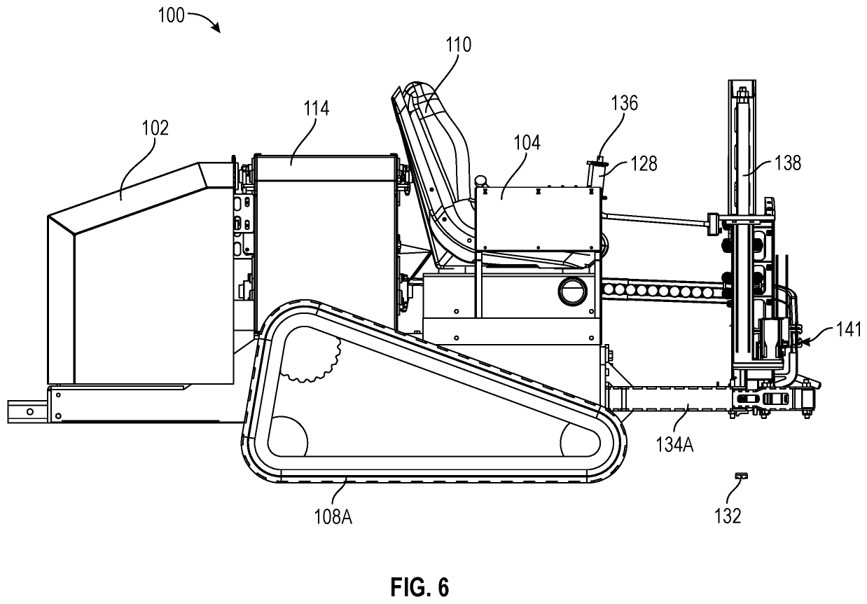

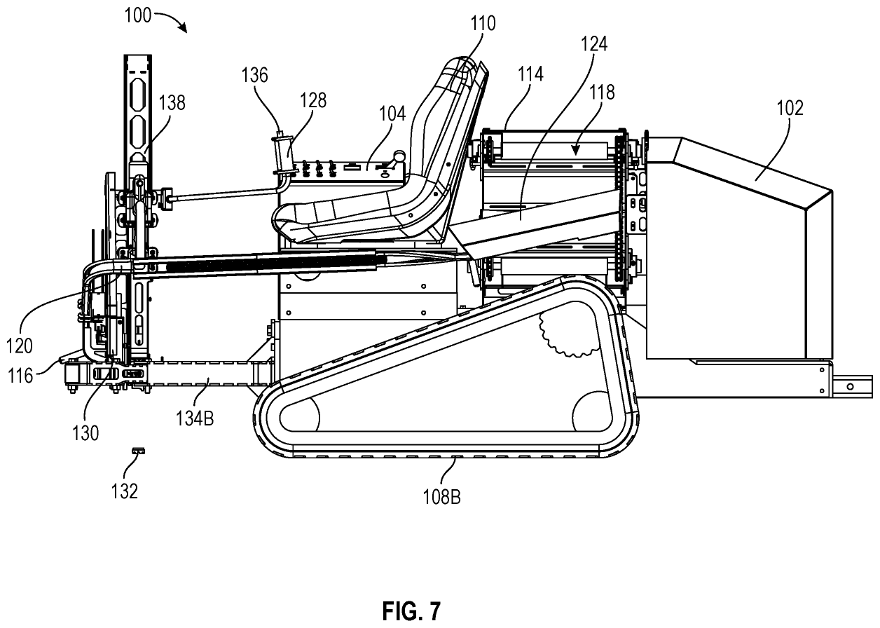

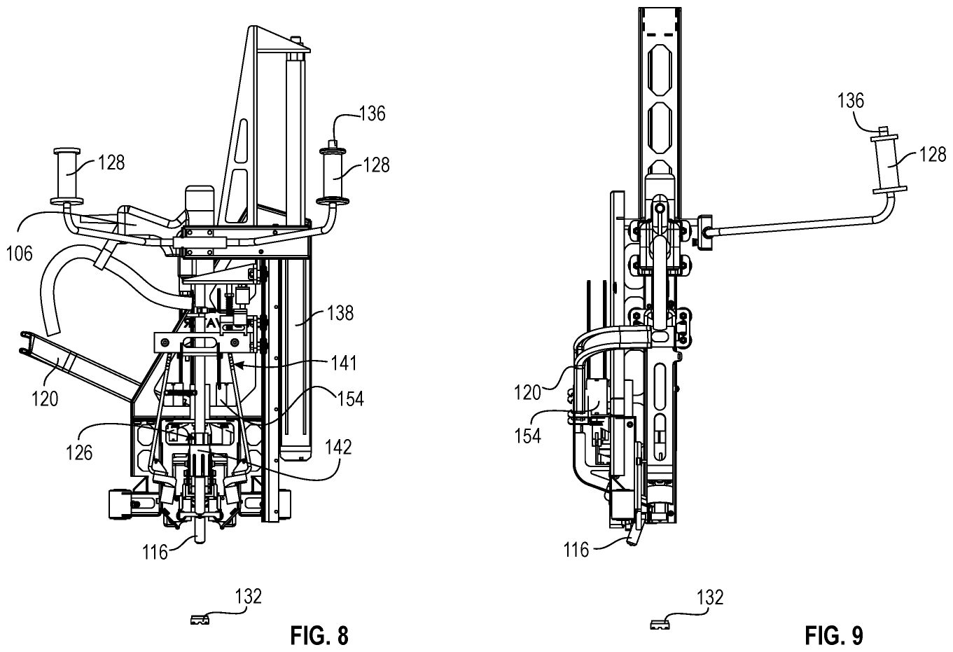

In addition to the above features, and as shown in FIGS. 4-7, the automated ride-on stud welder 100 may further comprise a collator 118 coupled to the storage bin 114 for automatically orienting the studs 116 and collating them. The studs 116 will then continue to a stud track 120 coupled to the storage bin 114 which allows the studs 116 to proceed down the stud track 120 to a stud welder collet 142 (shown in FIGS. 8 and 13). The stud track 120 runs along the side of the automated ride-on stud welder 100. To collate the studs 116, a roller chain flights 122 conveys studs 116 into an orientation chute 124 and aligns studs 116 into the stud track 120. Specifically, the roller chain flights 122 may comprise panels 121 and a chain 123 so as to gather and deposit the studs 116 into the orientation chute 124. While the roller chain flight 122 is described, the automated ride-on stud welder 100 is not so limited, and other mechanisms may be used to stir the studs 116 and convey or project them into the orientation and stud track 120. For example, in an alternate embodiment, the automated ride-on stud welder 100 may comprise a roller chain with lifting hooks. Once the studs 1116 are gathered by the roller chain flight 122, the studs 116 that are sent down the track 120 are sent to a stud indexing mechanism 126.

The automated ride-on stud welder 100 includes one or more handles 128, wherein the one or more handles 128 freely position a gantry 130 for fine adjustments by moving the gantry 130 in any direction. To ensure proper placement of the studs 116, the automated ride-on stud welder 100 is driven and positioned over a pre-spread ferrule 132. In addition, a laser pointer coupled to the gantry 130 may be used to center the stud 116 in the ring of the pre-spread ferrule 132. While a laser may be used, it will be appreciated that, in some embodiments, the automated ride-on stud welder does not comprise a laser pointer and uses another measuring mechanism to precisely place the studs. The gantry 130 secures the welding system 106 and stud attachment components. The gantry 130 is moved into position via actuating arms 134A, 134B. In particular, the actuating arms 134A, 134B allow the gantry 130 to move forward and backwards as well as laterally, left to right, thereby giving the welder control of positioning of the gantry 130 and stud welding system 106. To activate the stud welding process, a push button 136 located on a handle (e.g., handle 128), or any other location, can be pressed. While a push button 136 is shown, it will be appreciated that any other actuating mechanism may be used, such as a switch, lever, etc. Once the push button 136 is pressed, an electric actuator 138 causes the welding system 106 to descend to the welding position.

Referring to FIGS. 8-12, a stud holder mechanism 141 may comprise a stud holder 140 to position the stud 116, which stud 116 is seated in the stud collet 142 (shown in FIGS. 8-9) until the stud holder 140 releases the stud 116. The stud holder mechanism 141 may further comprise two mechanical arms 143A, 143B, a deck pressure spring 146, and a secondary glide 148. After the stud 116 has been released, the stud welding system 106 continues to descend. The two mechanical arms 143A, 143B resting together with a spring with a conical shaped guide 144 may center the pre-spread ferrule 132 upon contact and compress any decking or sheeting against the welding surface. To overcome the deck pressure spring 146, there must be sufficient downward force.

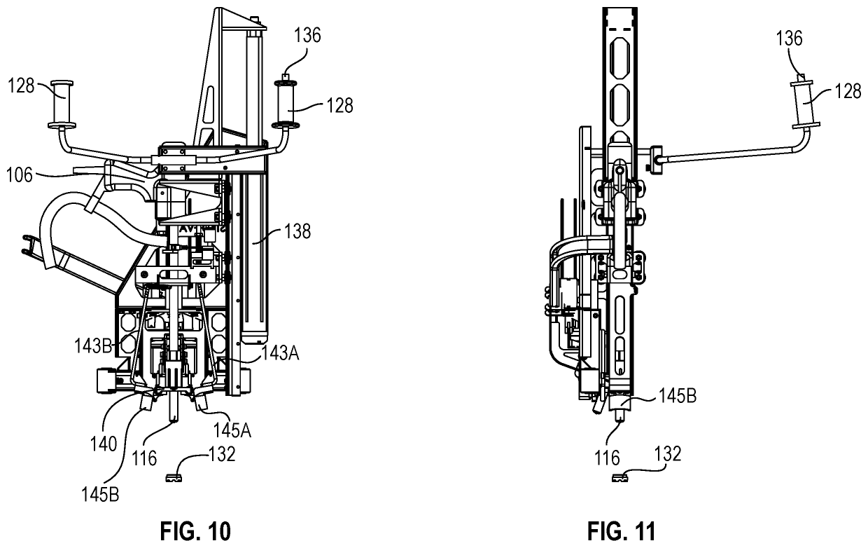

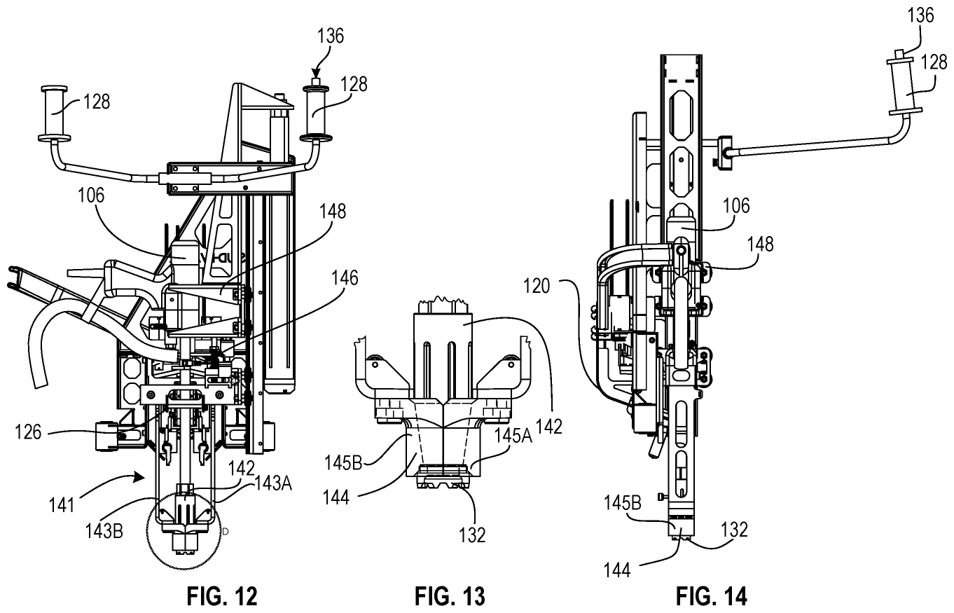

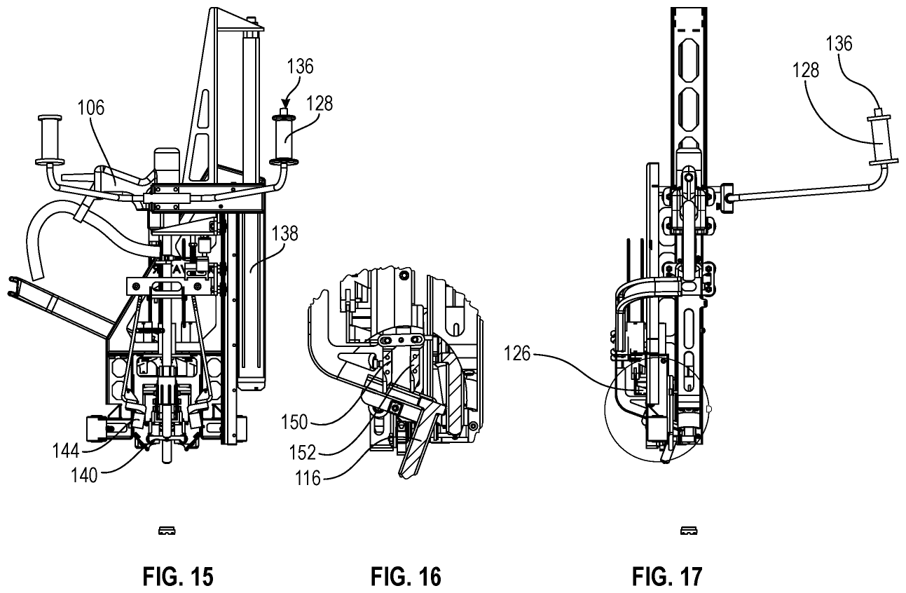

For example, FIGS. 8-9 illustrates the stud holder mechanism 141 and welding system 106 in a first, raised position, with mechanical arms 143A, 143B separated. FIGS. 10-11 illustrate stud 116 aligned with the ferrule 132 and the welding system 106 lowered to a second, intermediate position. FIGS. 12-14 illustrate the welding system 106 in a third, fully lowered position where the mechanical arms 143A, 143B are in a proximal, parallel position in relation to each other with the guide 144 (formed from abutting the distal ends 145A, 145B of each mechanical arm 143A, 143B) securing the stud 116, the stud 116 in contact with the ferrule 132 for welding. Once welded, the mechanical arms 143A, 143B separate as the welding system 106 is raised. Another stud 116 is then positioned for welding as discussed in FIGS. 15-17 below.

Referring to FIGS. 12-14, the secondary glide 148 will activate once the deck pressure spring 146 has been overcome with sufficient downward pressure that will allow the stud 116 to protrude through the center of the ferrule 132 until the stud 116 makes contact with the welding surface. For this to function properly, a signal system comprising one or more sensors and a microcontroller communicates with the stud welding system 106 to activate the welding cycle on the stud welder equipment, leading to the stud welding process. Once the signal system communicates with the stud welding system 106 upon activation, the signal system will also start the timing for the retraction process.

As shown in FIGS. 15-17, the stud welder mechanism 141 may further comprise the indexing apparatus 126 that delivers another stud 116 to the stud holder 140 upon full retraction of the stud welding system 106. The indexing apparatus 126 further comprises a lever action, or any other mechanical action, which is coupled with a leading finger 150 and a lagging finger 152 (as seen in FIG. 16), that raise and lower to allow the next stud in the track to position in between the indexing fingers 150, 152. The leading finger 150 is held in a down position (e.g., by using a spring) to prevent a continuous flow of collated studs 116. A solenoid 154 (shown in FIGS. 8-9) is activated approximately at the fully retracted stud welding gun position (FIGS. 8-9), which actuates the stud indexer 126 and overcomes the spring of leading indexing finger 150 allowing one stud 116 to move into the stud holder 140. This process will be repeated for each stud 116 that is welded to the welding surface.

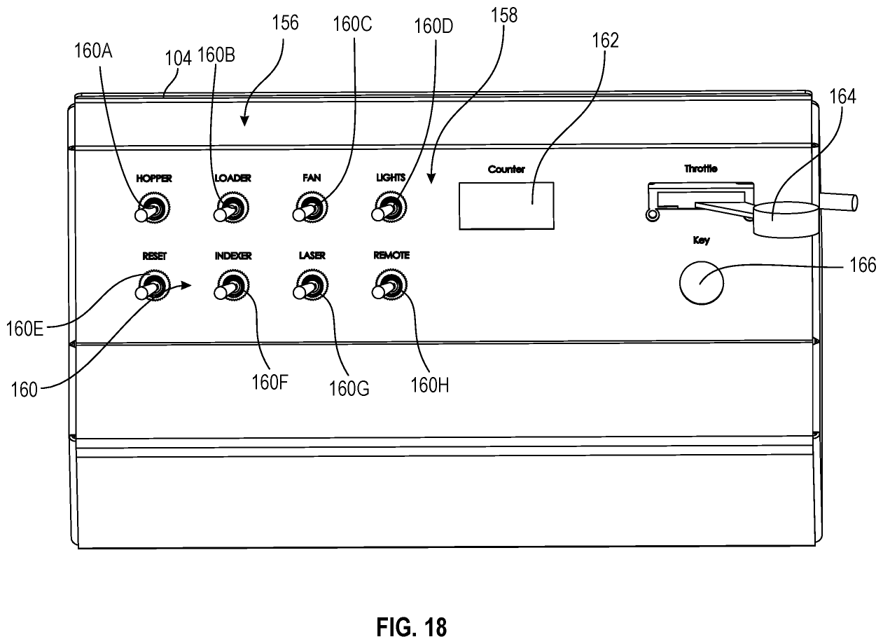

Referring to FIG. 18, the electrical system 104 may supply power to the electric actuator 138. Further the electrical system may comprise a housing 156 with a panel 158 that provides various options of actuating components of the automated ride-on stud welder 100. Specifically, the panel 158 may comprise a plurality of switches 160, such as a hopper switch 160A, loader switch 160B, fan switch 160C, light switch 160D, reset switch 160E, indexer switch 160F, laser switch 160G, and remote switch 160H. While the above-mentioned switches 160 are shown, the panel 158 is not so limited and may include more or less switches as well as different switches, such as a seat adjustment switch. As shown, there may also be a counter screen 162, a throttle lever 164, and a key 166 to start the automated ride-on stud welder 100. The counter screen 162 may notify the welder of the number of studs 116 in the track 120. In one embodiment, the counter screen 162 may notify the welder of the number of studs 116 previously welded. Further, it could be envisioned that, in other embodiments, the counter 162 notifies the welder of the number of studs 116 in the storage bin 114 based upon the type and weight of the stud 116. While switches 160 are shown on the panel 158, it will be appreciated other mechanisms may be used, such as a touch screen panel.

In an alternate embodiment, a support arm is attached to the back of the automated ride-on stud welder 100 and drags an electrical cord (when used) off center to help prevent the long electrical cord from becoming snagged on previously placed welded studs. The support arm, which can swing from the rear right to the rear left, promotes a more efficient stud welding process.

In one embodiment, the automated ride-on stud welder 100 comprises a fan for blowing hazardous fumes away from the operator. Again, this overcomes the prior art in which hazardous fumes are typically in the face of the stud welding individual that is operating a handheld or other general stud welder. The automated ride-on stud welder 100 may further comprise a plurality of guards to prevent sparks or other hazardous material from reaching the operator. The automated ride-on stud welder 100 may further comprise quick-attach pulleys that are coupled horizontally on the mezzanine deck, or whatever other type of surface for welding, to a desired row of studs that guide the electrical cables as needed to avoid the electrical cable snagging on previously welded studs.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. An automated ride-on stud welder comprising:
a chassis comprising a motor;
an electrical system for raising and lowering a stud welding system coupled to a gantry;
a storage bin for storing and transporting a plurality of studs;
a collator coupled to the storage bin to gather and deposit the studs into an orientation chute;
a track for receiving the studs from the orientation chute and for directing the studs to a stud holder mechanism and the stud welding system.

2. The automated ride-on stud welder of claim 1, wherein the motor is gas powered.

3. The automated ride-on stud welder of claim 1, wherein the stud welding system comprises a stud welding gun.

4. The automated ride-on stud welder of claim 1, further comprising a set of tracks for maneuvering.

5. The automated ride-on stud welder of claim 1, further comprising a seat.

6. The automated ride-on stud welder of claim 1, wherein the stud holder mechanism comprises a stud indexer, and a stud holder, and a stud collet for holding the stud in a stationary position prior to welding.

7. The automated ride-on stud welder of claim 1, further comprising an electrical system comprising a housing with a panel.

8. The automated ride-on stud welder of claim 7, wherein the panel comprises a plurality of switches.

9. The automated ride-on stud welder of claim 7, wherein the panel comprises a counter screen, a throttle lever, and a key.

10. An automated ride-on stud welder comprising:
a chassis comprising a motor coupled to the chassis, the motor controlling a set of tracks for maneuvering the chassis;
a storage bin for storing and transporting a plurality of studs;
a collator coupled to the storage bin to gather and deposit the studs into an orientation chute;
a stud track for receiving the studs from the orientation chute;
actuating arms coupled to a gantry;
one or more handles to position the gantry, the one or more handles comprising a push button that activates an electrical system for raising and lowering a stud welding system coupled to the gantry.

11. The automated ride-on stud welder of claim 10, further comprising an electric actuator for raising and lowering the gantry.

12. The automated ride-on stud welder of claim 10, wherein the stud welding system comprises a stud welding gun.

13. The automated ride-on stud welder of claim 10, wherein the gantry comprises a stud holder for positioning a stud prior to welding.

14. The automated ride-on stud welder of claim 10, further comprising a stud collet.

15. The automated ride-on stud welder of claim 10, further comprising a deck pressure spring.

16. The automated ride-on stud welder or claim 10, further comprising a stud indexer.

17. The automated ride-on stud welder of claim 10, wherein the electrical system comprises a housing with a panel.

18. The automated ride-on stud welder of claim 17, wherein the panel comprises a plurality of switches.

19. The automated ride-on stud welder of claim 17, wherein the panel comprises a counter screen, a throttle lever, and a key.

20. An automated ride-on stud welder comprising:
a chassis comprising a motor coupled to the chassis, the motor controlling a set of tracks for maneuvering the chassis;
a seat for a user;
a storage bin for storing and transporting a plurality of studs;
a collator coupled to the storage bin to gather and deposit the studs into an orientation chute;
a stud track for receiving the studs from the orientation chute, the track feeding the studs to a stud welding system;
actuating arms coupled to a gantry, the gantry controlling the position of the stud welding system;
one or more handles to position the gantry, the one or more handles comprising a push button that activates an electrical system for raising and lowering the stud welding system coupled to the gantry.
